(19) United States
(12) Patent Application Publication
(10) Pub. No.: US 2012/0012035 A1
(43) Pub. Date: Jan. 19, 2012

(54) METHOD FOR PRODUCING CHEMICALLY MODIFIED LIGNIN DECOMPOSITION PRODUCTS

(75) Inventors: Norman Blank, Ruschlikon (CH); Irene Schober, Zurich (CH); Philipp Rudolf Von Rohr, Muttenz (CH); Tobias Voitl, Zurich (CH)

(73) Assignee: SIKA TECHNOLOGY AG, Baar (CH)

(21) Appl. No.: 13/257,733

(22) PCT Filed: Mar. 19, 2010
(86) PCT No.: PCT/EP10/53647

§ 371 Date: Sep. 30, 2011

(30) Foreign Application Priority Data
Mar. 20, 2009 (EP) 09155705.8

(51) Int. Cl. C04B 24/00; C08F 289/00; C08H 7/00

(52) U.S. Cl. 106/802; 530/500; 530/505; 527/400; 530/502; 530/504; 526/204

(57) ABSTRACT

A method for producing chemically modified lignin decomposition products. To this end, a lignin-containing starting material is decomposed into low-molecular and high-molecular lignin decomposition products under acid conditions in the presence of a liquid medium, and the low-molecular lignin decomposition products are at least largely separated in order to obtain a high-molecular fraction. Subsequently, the high-molecular lignin decomposition products present in the high-molecular fraction are converted into chemically modified lignin decomposition products. The chemically modified lignin decomposition products obtained in this way can be used, for example, as dispersing agents, complexing agents, phenol component, flocculant, thickener or auxiliary agents for cementous systems, coatings, paints or adhesives.

### TECHNICAL FIELD

The invention relates to a method for producing chemically modified lignin decomposition products, to their use as dispersing agents and to a composition containing a chemically modified lignin decomposition product and a hydraulic binding agent.

### PRIOR ART

Next to cellulose, lignin is the most commonly occurring substance in living nature and is a main component of plants with the function of imparting rigidity to the cellular structure. The lignin component can vary from plant to plant. The chemical structure of lignin also has plant-specific differences. For instance, the macromolecule lignin is composed, according to the plant type, of different ratios of the monomers coniferyl alcohol, sinapyl alcohol and cumaryl alcohol, wherein in many instances, (in particular in soft woods) the component of coniferyl alcohol dominates. Moreover, there are numerous methods for separating the lignin from the other constituents of the cell wall, which in some cases significantly modify the chemical structure of the natural lignin.

Although various methods for producing chemicals from cellulose have reached a large industrial scale, there are currently almost no economical methods for using the lignin component of biomass as the starting material in the production of chemicals. For example, large amounts of lignin accumulate as byproduct or waste product in the production of paper. Of the approximately 50 million tons of lignin that accumulate yearly in the production of paper, only 1-2% are further processed commercially.

The use of lignin is limited primarily to relatively economical dispersing agents and binding agents. Vanillin is the only lignin-based phenolic product that is commercially produced. Part of the worldwide vanillin production (12,000 tons/year) is achieved through the alkaline, oxidative decomposition of lignin sulfonic acids.

Numerous methods for using lignin as raw material are described in the literature. One frequently used approach is the gassing of biomass at high temperatures (800-1000° C.) with air and/or water vapor to synthesis gas (CO, H₂, CO₂ and CH₄). Various basic chemicals, such as methanol, ether, formic acid and higher-molecular hydrocarbons can be prepared from this synthesis gas in further steps (by means of Fischer-Tropsch synthesis).

In this case, the originally present complex chemical structure is completely lost. This strategy of decomposition and recombination requires a lot of energy and produces undesired byproducts. In addition, only relatively simple, inexpensive molecules can be produced with this method. Therefore, high sales are required for economic productivity. Alternatively, various methods (e.g., oxidative and non-oxidative hydrolysis, hydrogenolysis, pyrolysis) are known for the direct production of monomeric or low-molecular chemicals. While these methods are suitable for decomposing lignin into smaller factions, no method is selective enough for producing a single product in a high yield.

WO 2008/106811 describes a method for the direct production of molecules with a minimal molecular weight of 78 g/mol from lignin. For this, lignin, lignin derivatives, lignin fractions and/or lignin-containing substances or mixtures are decomposed in the presence of at least one polyoxometallate to the desired products. The lignin fractions or lignin not converted to the target products are oxidized by oxygen to carbon dioxide and water or are used to obtain energy (e.g., thermal energy from oxidation).

Lignins or lignosulfonates can be widely used. For example, U.S. Pat. No. 6,313,055 and DE 101 16 849 A1 disclose lignosulfonates as dispersing agents or liquefying agents for hydraulic binding agents.

DE 100 57 910 A1 discloses the treatment of lignin with a reactive spacer in order to convert low-molecular constituents in such a manner that they are no longer volatile. Therefore, a chemical conversion of low-molecular molecules is disclosed here. However, as a result, these low-molecular molecules or their derivatives remain in the lignin. In addition, the low-molecular molecules are not made accessible for use elsewhere.

### PRESENTATION OF THE INVENTION

The problem addressed by the invention is that of making available a simple and reliable method for the chemical utilization of lignin, lignin derivatives, lignin fractions and/or lignin-containing substances or mixtures.

The problem is solved in accordance with the invention by the method according to Claim 1, the use according to Claim 15 and the product according to Claim 16. Preferred embodiments of the method are given in the dependent Claims 2 to 14.

According to the method of the present invention, chemically modified lignin decomposition products are produced from a lignin-containing starting material. The method of the invention comprises the following steps:
(a) Decomposition of a starting material selected from the group consisting of lignin, lignin derivatives, lignin fractions and/or lignin-containing substances or mixtures thereof under acidic conditions in the presence of a liquid medium to low-molecular and high-molecular lignin decomposition products, wherein the low-molecular lignin decomposition products have a maximum of three benzene ring units in their chemical structural formula and the high-molecular lignin decomposition products have more than three benzene ring units in their chemical structural formula,
(b) At least extensive separation of the low-molecular lignin decomposition products in order to obtain a high-molecular fraction, and
(c) Chemical modification of the high-molecular lignin decomposition products contained in the high-molecular fraction to chemically modified lignin decomposition products.

According to the invention, the chemical modification of the high-molecular lignin decomposition products according to step (c) takes place only after the steps (a) and (b).

The method in accordance with the invention permits a chemical utilization of high-molecular lignin decomposition products and therefore offers a technologically more valuable and more suitable alternative to the previously known methods for the oxidation or obtention of energy by combustion. The chemically modified lignin decomposition products are extremely well-suited, for example, as dispersing agents, for example, for cementitious systems, as complexing agents for polyvalent metal cations, as phenol components in binding agents or resins, or as flocculating agents, thickeners, components or auxiliary agents for coatings, paints, adhesives or resins. Thus, the method of the invention makes possible a very useful and suitable utilization of the renewable raw material lignin. As a result of the decomposition of lignin the number of chemically modifiable functional groups in the decomposed high-molecular lignin molecules can be increased. Furthermore, additional chemically modifiable functional groups not accessible without decomposition can be introduced into the decomposed high-molecular lignin molecules. This results in greater flexibility regarding the use of the chemically modified lignin decomposition products. As a result of the chemical modification, additional possibilities of functionalization are offered and therewith the possibility of adapting the properties of the final product further to the desired requirements. Conditioned by the decomposition of the lignin, the molecular weight of the chemically modified lignin decomposition products according to step c is less than that of the non-decomposed initial lignins chemically modified in the same way. The lower molecular weight facilitates the solubility of the final products, improves the compatibility with other components such as, for example, in formulations of cement liquefiers with other polymers, and improves the dispersing action.

The chemically modified lignin decomposition products obtained in accordance with the invention have no or very low amounts of low-molecular lignin decomposition products or chemically modified low-molecular lignin decomposition products on account of the step b. The presence of such, in particular phenolic, low-molecular lignin decomposition products or chemically modified low-molecular lignin decomposition products is especially undesirable because they can be toxicologically disadvantageous or because they can be washed out or dissolved out, particularly when used in hardenable materials, for example, concrete or mortar, after or during the hardening, which disadvantageously influences the properties, in particular the environmental compatibility of these hardened materials.

The low-molecular lignin decomposition products, for example, vanillin, separated in step (b) can be used elsewhere.

Thus, commercially interesting low-molecular lignin decomposition products as well as higher-quality, higher-molecular lignin decomposition products can be obtained from lignin at the same time with the present method, which enables the highest possible obtention of value from the raw material lignin.

The term lignin describes an entire class of substances. This is known to the person skilled in the art.

In principle, chemically modified lignin decomposition products can be obtained from all lignin types independently of origin and pretreatment with the method in accordance with the invention. It is also possible to carry out a selective pretreatment of the lignin used in order, for example, to modify the solubility in organic and/or inorganic solvents. It is further possible to use a lignin which has already been partially decomposed.

The decomposition takes place by the splitting of bonds in the lignin structure, as a result of which the molecular weight of the lignin is reduced and thus results in decomposition products that represent, according to the molecular weight, low-molecular or high-molecular lignin decomposition products in the sense of this document.

In a preferred embodiment, the decomposition is carried out in accordance with step (a) of the method of the invention in the presence of at least one polyoxometallate. In contrast to the conventional methods for the decomposition of lignins, which are usually based on purely chemophysical methods (high temperature and pressure), and on simple acid- or base-catalyzed hydrolysis, in this case polyoxometallates make possible the selective splitting of bonds and therewith the decomposition of lignin already at comparatively low temperatures. The use of polyoxometallates as catalysts for the decomposition of lignin, lignin derivatives, lignin fractions, lignin-containing substances and mixtures is described in WO 2008/106811, the disclosed content of which is expressly included by reference in this regard.

Refer also regarding possible polyoxometallates to WO 2008/106811, where they are described in detail. Okuhara et al. (2001) Applied Catalysis A: General 222:63-77, the disclosed content of which is expressly included by reference in this regard.

Polyoxometallates of molybdenum and phosphorus have proved to be especially suitable. Phosphomolybdic acid (H₃PMo₁₂O₄₀, can also be prepared as H₃[PMo₁₂O₄₀]) proved to be most preferred, which is also designated by the person skilled in the art as 12-phosphomolybdic acid.

Polyoxometallates are preferably used in step (a) in an amount of 0.01-50 g, preferably 0.1-10 g per 1 g starting material.

In another preferred embodiment, the decomposition according to step (a) is carried out in the presence of at least one acid, in particular in the presence of an acid with a pKₐ₁ of less than 3, preferably less than 2.5. The use of an acid is a simple and economical alternative to the polyoxometallate catalysts. It is advantageous in using such acids that the acids can be readily neutralized and do not disadvantageously influence the chemical modification in step (c), even without separation. On the contrary, it can also be absolutely advantageous that these acids even support or catalyze the chemical modification. Most acids are also more economical than the polyoxometallates. Inorganic as well as organic acids can be used, for example, HCl, H₂SO₄, H₂SO₃, HNO₃, HNO₂, H₃PO₄,

H₃PO₃, sulfonic acids, especially benzene sulfonic acid, methane sulfonic acid or trifluoroacetic acid, trichloroacetic acid.

In step (a) such acid(s) can also be used in combination with polyoxometallate(s).

One embodiment of step (a) provides for reacting a starting material selected from the group consisting of lignin, lignin derivatives, lignin fractions, lignin-containing substances and mixtures thereof in the presence of at least one polyoxometallate or at least one acid in a suitable reactor. To this end the starting material and the at least one polyoxometallate or the at least one acid are dissolved or suspended in a suitable liquid medium. The mixture is brought for a sufficiently long time to conditions that promote the decomposition of lignin.

In this case, the pH can lie or can be adjusted to a range of 0.5 to 6, preferably in a range of 1 to 3. Under these acidic conditions an optimal reaction of the lignin-containing starting material that is used to the low-molecular and high-molecular lignin decomposition products is carried out.

The decomposition of the lignin-containing starting material is preferably carried out at a temperature of 20 to 300° C., in particular at a temperature of 100 to 200° C.

The decomposition of lignin can be carried out here at a superpressure of 0 to 200 bar, preferably at a superpressure of 0 to 50 bar. The decomposition preferably takes place in the presence of N₂, air or O₂, preferably O₂.

Particularly good results of the decomposition, i.e., especially high yields of low-molecular lignin decomposition products, have been achieved when the decomposition takes place in a reactor with a superpressure of oxygen and at a temperature of 100 to 200° C. and in the presence of an acid with a pKₐ₁ of less than 3 and/or with a polyoxometallate.

The decomposition of lignin in step (a) can also take place in a continuous process instead of in a batch-wise, discontinuous process. This has the advantage in particular of less expense for working and cleaning, and consequently reduces the cost of the decomposition process and is especially preferred primarily for the industrial, large-volume decomposition of lignin and the chemical modification of lignin decomposition products. The polyoxometallates advantageously used in such a continuous process are advantageously continuously separated from the reaction mixture and returned to the process.

According to a preferred embodiment, the decomposition according to step (a) is carried out in the presence of at least one compound that prevents a recombination of decomposition products. Such compounds are in particular radical interceptors.

The way in which the term “radical interceptor” is understood in connection with this document is defined in the following.

Radical interceptors serve in the framework of this invention to intercept radicals formed during the decomposition of lignin and to prevent reactions of repolymerization in this way. In particular, the yield of the desired lignin decomposition products to be chemically modified are to be increased in this manner.

In one preferred embodiment, the decomposition is carried out in the presence of a radical interceptor selected from the group consisting of alcohols, preferably methanol or ethanol; organic acids, preferably ascorbic acid; phenols, preferably butylhydroxytoluene; and stabilized free radicals, preferably nitroxyl radicals.

Another embodiment provides for reacting lignin-containing starting material in the presence of two liquid phases. In distinction from decomposition in only one liquid phase, here two liquid phases that are only partially miscible or non-miscible are in contact with one another. The two liquid phases preferably have a substantially different polarity. On account of different solubilities of polyoxometallate(s) or acid, of lignin and of lignin decomposition products in the selected liquid phases, a partial or complete separation of the components can take place. It is possible, for example, to select a system with two liquid phases, wherein lignin, the high-molecular lignin decomposition products and polyoxometallate(s) are dissolved or suspended primarily in the first liquid phase (e.g., water), and the second liquid phase offers a higher solubility for the low-molecular lignin decomposition products (e.g., chloroform). In this manner the low-molecular lignin decomposition products can be separated from the reaction medium before they further react in successive reactions. The decomposition of the lignin in the presence of two liquid phases is preferably also carried out in the presence of a radical interceptor.

It is advantageous if the liquid medium used in step (a) is water, optionally in combination with alcohol. An alcoholic radical interceptor, in particular methanol and/or ethanol, is preferably used during the decomposition, wherein the volumetric ratio of water to an alcoholic radical interceptor is especially preferably in a range of 1:10 to 10:1.

The at least extensive separation of the low-molecular lignin decomposition products can be carried out, for example, by distillation or extraction or precipitation or filtration or ultrafiltration. Extraction and ultrafiltration by means of a membrane that typically has an exclusion limit (cut-off) of 100 Daltons or 1000 Daltons have proven to be especially suitable. Moreover, it is also possible to separate out all further components, e.g., solvents or excess reagents, in addition to the low-molecular lignin decomposition products.

It has been found that the advantages found in the framework of the present invention appear most strongly in the most complete separation of the low-molecular lignin decomposition products that is possible.

In one preferred embodiment, the separation of the low-molecular lignin decomposition products in step (b) is such that in the chemically modified lignin decomposition product according to step (c), the percentage of the total of low-molecular lignin decomposition products and chemically modified low-molecular lignin decomposition products is less than 20 wt. %, in particular less than 10 wt. %, preferably less than 5 wt. % and most preferably less than 1 wt. %.

It has been found that in particular the separation of the low-molecular constituents that have only one benzene ring (designated as “monomers” in this context), corresponding to a molecular weight Mw of the low-molecular decomposition products of less than 200 g/mol, is advantageously as complete as possible. The quantity of monomers present after step (a) in the reaction mixture is preferably separated by step (b) to more than 90 wt. %, in particular to more than 95 wt. %, preferably to more than 97 wt. %. The high-molecular fraction after step (b) advantageously has less than 5 wt. %, in particular less than 2 wt. %, preferably less than 1 wt. % monomers.

It is possible in principle to carry out step (b) during step (a), i.e., for the separation of the low-molecular lignin decomposition products to take place at least partially during the decomposition of the starting material, for example, by extraction in one operation (reactive extraction) or by separation (filtration) via a membrane in a membrane reactor.

The phenolic products separated as low-molecular lignin decomposition products can be supplied for another use, for example, as educts for the production of organic compounds.

The chemical properties of the high-molecular lignin decomposition products can be determined in such a manner by the chemical modification in step (c) that the modified products are suited for the desired use. Depending on the desired use, the high-molecular lignin decomposition products can be chemically modified, for example, by etherification, esterification, alkoxylation, sulfonization or graft polymerization. The chemical modification of the high-molecular lignin decomposition products preferably comprises a reaction selected from the group consisting of addition, condensation and graft polymerization.

After step (b) the high-molecular lignin decomposition products contain in particular chemically modifiable groups selected from the group consisting of aliphatic alcohol groups, aromatic alcohol groups, (phenolic groups), carboxylic acid groups and carbonyl groups. In addition, they can come under certain circumstances as radicals from step (b). In particular, such groups are accessible to the chemical modification in step (c).

Furthermore, typical reactions on aromatic nuclei such as electrophilic substitutions can take place as chemical modification in step (c).

In a preferred embodiment, the chemical modification of the high-molecular lignin decomposition products is carried out by reaction with at least one reactant selected from the group consisting of alcohols, carboxylic acids, hydroxy carboxylic acids, amino acids, acid chlorides, acid anhydrides, sulfonic acids, hydroxysulfonic acids, aminosulfonic acids, sulfamic acid, esters, lactones, lactams, alkylhalogenides, epoxides, amines, hydroxylamines, sulfuric acid, oleum, chlorosulfonic acid, adducts from SO₃ such as, e.g., on DMF or pyridine, and olefinically unsaturated compounds.

A few typical chemical modification reactions are indicated here in the following—schematically shown—as examples of such especially preferred addition reactions or condensation reactions:

Chemical Modifications of Alcohol Groups of High-Molecular Lignin Decomposition Products: Alkoxylation:

Phenolic and the non-phenolic alcohol groups in the high-molecular lignin decomposition products can be reacted, for example, under conditions customary for alkoxylation with ethylene oxide, propylene oxide or butylene oxide or mixtures thereof. Depending on the control of the reaction and the amount of alkylene oxide used, polyalkylene oxide chains with different lengths and compositions can be attached in this manner to the decomposed lignin molecule. The following chemical groups can be introduced by alkoxylation as a typical example of this:

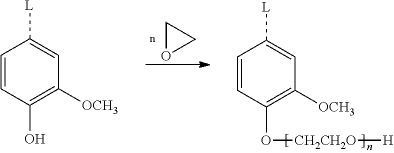

The group L connected via a dashed-line bond represents the polymeric basic structure of a high-molecular lignin decomposition product before and after chemical modification in the above and in the following formulas. It is understood, of course, that even more—and different—functionalities of the ones shown can be affixed to such a polymeric basic structure.

Chemical Modifications of Alcohol Groups of High-Molecular Lignin Decomposition Products: Addition of Epoxides:

Phenolic and the non-phenolic alcohol groups in the high-molecular lignin decomposition products can be further added to epoxides such as, for example, epoxidized fatty acids, glycidylmethacrylate or epoxidized maleic acid. The following chemically modified groups can be obtained by addition to expoxides as a typical example of this:

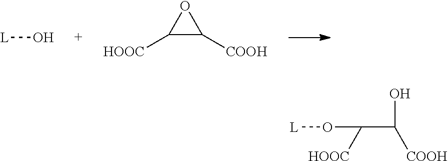

Chemical Modifications of Alcohol Groups of High-Molecular Lignin Decomposition Products: Hetero-Michael Addition:

Possible alcohol groups present in the decomposed lignin can be etherified with compounds containing activated C═C double bonds in a hetero-Michael addition. Suitable compounds are, for example, (meth) acrylic acid, (meth) acrylic acid esters, (meth) acrylamides, (meth) acrylonitrile, vinylsulfonic acid or vinyl phosphonic acid. Other possible compounds are maleic acid, crotonic acid or itaconic acid or their mono- or diesters and -amides, as well as the monoamide of maleic acid with sulfanilic acid. The following chemically modified groups can be obtained by addition to activated C═C double bonds as a typical example of this:

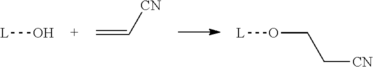

Chemical Modifications of Alcohol Groups of High-Molecular Lignin Decomposition Products: Esterification:

Phenolic and the non-phenolic alcohol groups in the high-molecular lignin decomposition products can be esterified with mono- or dicarboxylic acids or their anhydrides or acid chlorides, or can be transesterified with simple carboxylic acid esters. Examples of this are acetic acid, maleic acid, fumaric acid, phthalic acid or fatty acids such as lauric acid or oleic acid, their anhydrides, acid chlorides or simple esters. The following chemically modified groups can be obtained by esterification as a typical example of this:

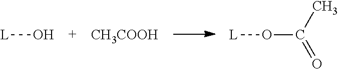

Chemical Modifications of Phenolic Groups of High-Molecular Lignin Decomposition Products: Methylolization & Mannich Base Production:

Aromatic nuclei with aromatic alcohol groups, i.e., phenolic rings, can react with formaldehyde to methylol compounds that can be further reacted. The reaction of the aromatic nuclei, particularly of the phenolic rings, with formaldehyde or other aldehydes and amines or polyamines result in Mannich bases. Alanine has proven to be an especially suitable amine for this. Alanine can be further functionalized as required. The following chemically modified groups can be obtained as typical examples of this:

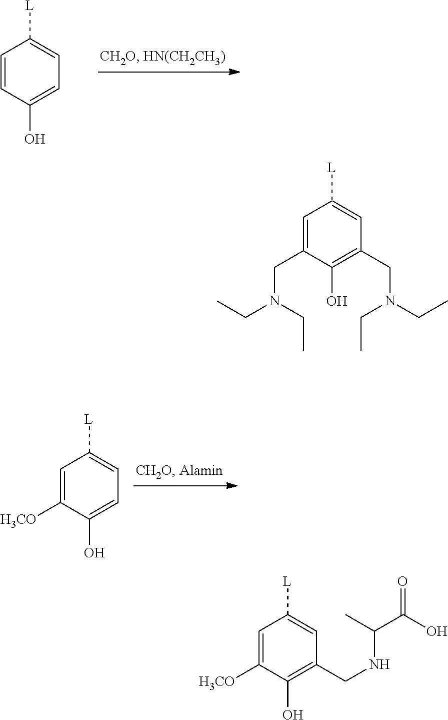

Chemical Modifications of Carboxylic Acid Groups or Carboxylic Acid Ester Groups of High-Molecular Lignin Decomposition Products: Esterification, Amidization:

Carboxylic acid groups or carboxylic acid ester groups in the high-molecular lignin decomposition products can be converted with alcohols or amines or also with epoxides to the corresponding esters or amides. Examples of such reactions are esterification or amidization with α-alkoxy-α-hydroxy-polyalkylene glycols or α-alkoxy-ω-amino-polyalkylene glycols, preferably α-methoxy-ω-hydroxy-polyethylene glycols, α-alkoxy-ω-amino-polyethylene glycols or α-alkoxy-ω-amino-poly(ethylene/propylene glycols), or esterification with fatty alcohols such as, for example, lauryl alcohol or oleyl alcohol.

Chemical Modifications of Aldehyde Groups or Ketone Groups of High-Molecular Lignin Decomposition Products:

Aldehyde groups or keto groups in the high-molecular lignin decomposition products can be converted with sulfite to the corresponding hydroxy sulfonic acids. The following chemically modified groups can be obtained from aldehyde groups as a typical example of this:

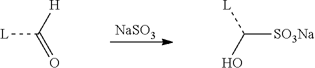

Furthermore, high-molecular lignin decomposition products can be reacted in a radical graft polymerization with at least one olefinically unsaturated compound. The at least one olefinically unsaturated compound is preferably selected from the group consisting of alkenes, dienes, olefinically unsaturated acids, olefinically unsaturated esters, olefinically unsaturated acid anhydrides, olefinically unsaturated amides, olefinically unsaturated ethers and olefinically unsaturated alcohols, preferably selected from the group consisting of acids or anhydrides or esters or amides of acrylic acid, methacrylic acid, maleic acid, fumaric acid or itaconic acid, vinyl ethers, vinyl sulfonic acids, vinyl esters, allyl alcohol and allyl ether.

Such olefinically unsaturated compounds are in particular (meth)acrylic acid, maleic acid, fumaric acid, crotonic acid or itaconic acid, esters thereof, hydroxyethyl(meth)acrylate, hydroxypropyl(meth)acrylate, (meth)acrylamide, 2-acrylamido-2-methyl-1-propane sulfonic acid, the semi-acid from maleic acid and sulfanilic acid, polyalkylene glycol-(meth)acrylates or maleic acid-polyalkylene glycol-mono- or maleic acid-polyalkylene glycol-diesters or -amides, styrene, styrene sulfonic acid, vinyl acetate, N-vinyl pyrrolidone, vinyl-polyalkylene glycols, vinyl sulfonic acid, vinyl phosphoric acid or allyl-polyalkylene glycols.

These graft (co) polymerizations take place as a rule with a suitable initiator and, as required, molecular weight regulators and/or reduction agents. Examples of initiators are peroxides such as hydrogen peroxide or dibenzoyl peroxide (DBPO), persulfates such as sodium-, potassium- or ammonium persulfate, hydroperoxides such as cumol hydroperoxide or azo compounds such as azobisisobutyronitrile (AiBN). Hydrogen peroxide and persulfates are preferred. Suitable regulators are, for example, allyl compounds, alcohols, aldehydes, sulfur compounds such as, e.g., mercaptans, such as thiomalic acid, mercapto propionic acid, dodecylmercaptan, suitable reduction agents are, for example, alkali sulfites or alkali hydrogen sulfites, alkali phosphites, ascorbic acid, thiosulfates or rongalite or also transitional metals, e.g., FE(II) salts.

Graft polymerization is preferably carried out with H₂O₂ together with Fe(II) sulfate and rongalite or with alkali persulfate and alkali sulfite. If, however, water-insoluble monomers are used, polymerization is preferably carried out in an organic solvent. In this case it is recommended to use initiator systems that are soluble in organic solvents such as, for example, AiBN or DBPO.

Furthermore, typical reactions on aromatic nuclei, such as electrophilic substitutions, can be carried out as chemical modification in step (c). Aromatic nuclei, in particular phenolic rings, in the high-molecular lignin decomposition products can be sulfonated, for example, with oleum or sulfuric acid or sulfomethylated with formaldehyde and sulfite. The following chemically modified groups can be obtained as a typical example of this:

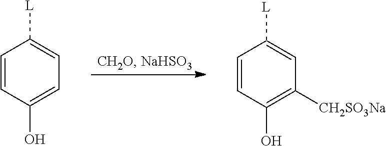

It is clear to the person skilled in the art that even more reaction steps can be carried out sequentially or also simultaneously in the framework of the invention for modification. For instance, a high-molecular lignin decomposition product can be alkoxylated, for example, in a first step and in a second step the alcohol groups produced and those still present can be esterified. Or, amino groups are introduced in a first step, which are reacted in a second step with epoxides. Or, a sulfonization on the aromatic is performed in a first step, and in a second step the alcohol groups are reacted with alkylene oxide. Also, more than one functional group can be reacted at the same time, e.g., alkoxylation can be carried out at the same time on the aromatic as well as on the aliphatic alcohol group.

Decomposition of the starting material is advantageously of a very striking extent. As a result thereof, the molecular weight is greatly lowered. The term “molecular weight” always denotes in the present document the molecular weight M_{W} averaged by mass, which is determined by SEC (Size Exclusion Chromatography).

The SEC analysis was carried out on an HPLC system (Alliance 2695, Waters) equipped with a column cascade of the company Polymer Standards Service GmbH (MCX 10 m 1000 Å, MCX 10 μm 100000 Å+pre-column) and a UV detector (320 nm). 0.01 molar aqueous sodium hydroxide solution was used as the mobile solvent and solvent for lignin and the lignin decomposition products. Calibration was carried out by means of 9 narrow polymer standards from sulfonated polystyrene in the molecular weight range 1,020,000 Da to 3,420 Da. The molecular weight averaged by mass was therefore determined relative to the sulfonated polystyrene.

In a preferred embodiment, the molecular weight M_{W} averaged by mass of the high-molecular lignin decomposition products after step (a) is less than 80% of the molecular weight of the starting material used in step (a), preferably less than 60%. Thus, the decomposition that takes place in step (a) advantageously results in a very striking reduction of the molecular weight and therewith in a substantial decomposition of the lignin.

The present invention further relates to the use of a chemically modified lignin decomposition product produced by a method in accordance with the invention as a dispersing agent. Alternatively, the chemically modified lignin decomposition products can also be used as complexing agents for polyvalent metal cations, as phenol components in binding agents or resins, or as flocculation agents, thickeners, components or auxiliary agents for coatings, paints, adhesives or resins.

The present invention further relates to a composition containing at least one chemically modified lignin decomposition product produced by a method in accordance with the invention and at least one hydraulic binding agent.

In the present document basically all hydraulically setting substances known to the person skilled in the art of concrete are understood as “hydraulic binding agents”. The hydraulic binding agents particularly involve cements such as, for example, Portland cements or high-alumina cements and also mixtures thereof with flue dusts, silica fume, slags, smelting-works sands and limestone fillers. Furthermore, however, even the hydraulically setting substances of gypsum, in the form of anhydrite or semi-hydrate, or burnt lime are understood to be hydraulic binding agents. Cement is preferred as the hydraulically setting binding agent.

The composition can comprise other constituents in addition to hydraulic binding agent and chemically modified lignin decomposition product. Such other constituents are additive substances such as sand, gravel, stones, quartz meal, chalks, limestone fillers and as additives, customary constituents such as concrete liquefiers, for example, lignosulfonates, sulfonated naphthalene-formaldehyde condensates, sulfonated melamine-formaldehyde condensates or polycarboxylate ethers, accelerators, corrosion inhibitors, retarders, shrinkage reducers, defoamers or pore formers.

Such compositions harden, as a consequence of the reaction of the hydraulic binding agent with water, under the influence of water. In particular, such compositions can be used as mortar compounds or concrete compounds.

It has turned out that the chemically modified lignin decomposition products are best suited as dispersing agents, in particular as dispersing agents for hydraulic binding agents, especially for cement and gypsum.

In addition, the chemically modified lignin decomposition products have a liquefying effect on hydraulic binding agents and on compositions containing hydraulic binding agents. That is, when a previously described, chemically modified lignin decomposition product is used, a hydraulic binding agent or a composition comprising a hydraulic binding agent has a more liquid consistency or greater flow behavior than the corresponding hydraulic binding agent or the composition comprising the hydraulic binding agent without chemically modified lignin decomposition products with the same amount of water. Worded differently, the chemically modified lignin decomposition products reduce the water requirement of a hydraulic binding agent and/or of a composition comprising the hydraulic binding agent in order to achieve a certain flow behavior. The flow or the flow behavior is typically determined by the so-called spreading mass, measured according to EN 1015-3.

It has proven to be especially advantageous that the chemically modified lignin decomposition products described in the framework of this invention have, in particular, a higher liquefying effect on hydraulic binding agents, compared both with the corresponding chemically modified lignin decomposition products in which the low-molecular lignin decomposition products were not separated before the chemical modification, and with the corresponding chemically modified lignins that were not subjected to a lignin decomposition before the chemical modification. The greater liquefying effect of the chemically modified lignin decomposition products disclosed in the framework of the invention in hydraulic binding agents is expressed in improved processing properties and in a lesser water requirement for achieving a certain processing consistency, which experience has shown to be expressed in greater mechanical properties of the hardened hydraulic system. On the other hand, the same processing consistency can be achieved on account of the improved liquefying effect even with a greatly reduced addition of chemically modified lignin decomposition products in comparison with the corresponding, known, non-decomposed lignins, which can nevertheless result in significant savings in the final usage in spite of the raw material costs made slightly more expensive by decomposition, separation and chemical modification.

It was further found that the low-molecular lignin decomposition products formed during lignin decomposition can be separated in a simple and very efficient manner, which is extremely advantageous for their obtention and other uses and is highly interesting commercially.

The method presented in this document thus has a significant potential for achieving great value from lignin, a raw material that is present in nature in large amounts and also accumulates as a waste product, while thereby creating little or no waste products.

### EXAMPLES

The examples cited in the following serve to illustrate the invention and are not to be understood in any way as limiting the invention.

The following lignins were used for the examples:

Lignin 1: Indulin® AT, a non-modified kraft lignin of the MeadWestvaco company (USA), obtainable, for example, from Staerkle&Nagler AG, Zollikon, Switzerland

Lignin 2: slightly sulfonated pine kraft lignin supplied by the Sigma Aldrich company, Switzerland.

### Lignin Decomposition by Sulfuric Acid/Separation

### Example 1

### Lignin 1/Separation Via Extraction

A mixture of 80 mL methanol and 20 mL water was produced as reaction mixture. The pH of the solution was adjusted by the addition of a few drops of concentrated sulfuric acid with simultaneous measuring by a Polilyte HT120 sensor (Hamilton Bonaduz AG, CH-Bonaduz) to pH 1.10. The solution was subsequently transferred into a 400 mL autoclave (Premex Reactor AG, CH-Lengnau) provided with a gassing agitator. Before the reactor was closed, 1 g lignin 1 was added. The mixture was then loaded three times with 11 bar oxygen, which was then let off again in order to displace the initially present air in the reactor. Finally, the reactor was filled with 11 bar oxygen and the mixture heated at an agitator speed of 1000 RPM with a rate of 8 K/min to 170°. The mixture was held at 170° C. for 20 min. and subsequently cooled off within 60 min. to below 30° C. The reactor was then decompressed, opened and the liquid reaction mixture (including the accumulating solid) removed. In order to obtain the decomposed lignin as completely as possible from the reactor, the interior of the reactor was freed of solid deposits, the reactor was washed with a little water and the wash water was added to the reaction mixture. This reaction mixture is designated in the following as RG1.

After the filtering off of the solid S1 the filtrate was extracted three times with 30 mL chloroform each time in a separatory funnel and the extract separated off. The combined chloroform extracts are designated as Ex-C1 and the aqueous phase as Ex-W1. Ex-W1 contained practically no lignin decomposition products.

The solid S1 was pre-dried on a rotary evaporator and finally freeze-dried and designated as separated high-molecular lignin decomposition product AHLA1.

### Example 2

### Lignin 2/Separation Via Extraction

Example 2 was carried out in a manner analogous to example 1 except that instead of lignin 1, lignin 2 was used. The corresponding reaction mixture is accordingly designated in the following as RG2, the solid as S2, the chloroform extract as Ex-C2 and the aqueous phase as Ex-W2. Since the aqueous phase Ex-W2 still contained lignin decomposition products, in example 2 the solid S2 was combined with aqueous phase Ex-W2, mixed, pre-dried on a rotary evaporator and finally freeze-dried and the separated high-molecular lignin decomposition product designated as AHLA2.

### Example 3

### Lignin 2 (Larger Autoclave)/Separation Via Ultrafiltration

Example 3 was carried out in a manner analogous to example 1 except that instead of lignin 1, lignin 2 was used and a larger amount of lignin was used. The corresponding reaction mixture is accordingly designated in the following as RG3. This reaction mixture was adjusted with NaOH to pH 10.7, evaporated to low bulk on a rotary evaporator and subsequently freeze-dried. Of the 7.5 g solid obtained, the greatest part of the low-molecular decomposition products as well as of the salts was separated by ultrafiltration with a 1000 Dalton membrane. During the ultrafiltration, the solution is separated in an agitated ultrafiltration cell (300 mL volume) at a pressure of approximately 4 bar via a membrane with an indicated exclusion boundary (e.g., 1000 Daltons here). The phase that passes the membrane is designated as filtrate and the remaining phase is designated as residue. The filtrate obtained here has been designated as filtrate F3. The residue was evaporated to low bulk on a rotary evaporator and freeze-dried. 1.3 g of a powder with an organic carbon content of 48.0% (determined by TOC measurement) was obtained. This residue represents the separated high-molecular lignin decomposition product and is designated as AHLA3.

The TOC (Total Organic Carbon) values indicated in this document were determined by measurements using a Sievers 5310C, laboratory TOC analyzer from the company Ionics Instruments, in a known manner.

### Lignin Decomposition by Means of POM: H₃PMo₁₂O₄₀/Separation

### Example 4

### Lignin 2/Separation Via Extraction

9.128 g H₃PMo₁₂O₄₀ (phosphomolybdic acid, No. 31426, Sigma-Aldrich, CH-Buchs) were dissolved in a mixture of 80 mL methanol and 20 mL water, which corresponds in form to a 0.05 molar solution. The pH of the solution was then determined using a Polylite HT120 sensor (Hamilton Bonaduz AG, CH-Bonaduz) at 1.13. The solution was subsequently transferred into a 400 mL autoclave (Premex Reactor AG, CH-Lengnau) provided with a gassing agitator. Before the reactor was closed, 1 g lignin 2 was added. The mixture was then loaded three times with 11 bar oxygen which was then let off again in order to displace the initially present air in the reactor. Finally, the reactor was filled with 11 bar oxygen and the mixture heated at an agitator speed of 1000 RPM at a rate of 8 K/min to 170°. The mixture was held at 170° C. for 20 min. and subsequently cooled off within 60 min. to below 30° C. The reactor was then decompressed, opened and the liquid reaction mixture (including the accumulating solid) removed. In order to obtain the decomposed lignin as completely as possible from the reactor, the interior of the reactor was freed of solid deposits, the reactor was washed with a little water and the wash water was added to the reaction mixture. This reaction mixture is designated in the following as RG4.

After filtering off the solid S4, the filtrate was extracted three times with 30 mL chloroform each time in a separatory funnel and the extract separated off. The combined chloroform extracts are designated as Ex-C4 and the aqueous phase as Ex-W4. Solid S4 and the aqueous extract Ex-W4 were combined, mixed, the pH adjusted with NaOH to approximately 10, then pre-dried on a rotary evaporator and finally freeze-dried and designated as separated high-molecular lignin decomposition product AHLA4.

Several corresponding reactions were carried out in order to provide sufficient material of examples 1 to 4 for the chemical reactions and tests.

### Chemical Reaction

Sulfatizing the Separated, High-Molecular Lignin Decomposition Product AHLA1:B1

1.0 g of the separated high-molecular lignin decomposition product AHLA1 were almost completely dissolved in 10 mL dry DMSO and 0.22 g sulfaminic acid added. The reaction mixture was agitated 17 hours at 80° C. After it had cooled to room temperature, the reaction mixture was poured onto 300 mL ethanol in which 1.3 g NaOH were dissolved. The resulting precipitate was filtered off and rewashed with ethanol. The precipitate that precipitated further from the filtrate after 2 days in the refrigerator was also filtered off and combined with the first filtrate and dried. The solid was dissolved in water, the pH adjusted with NaOH to approximately 12 and the solution ultrafiltered via a 1000 Dalton membrane in order to remove the greatest part of the inorganic salts. The residue was freeze-dried, wherein 0.7 g of a brown powder was obtained, designated as B1. The TOC measurement of the dry residue yielded 50.2% organic carbon.

Sulfatizing the Separated High-Molecular Lignin Decomposition Product AHLA2:B2

1.52 g of the separated high-molecular lignin decomposition product AHLA2 were dissolved in 20 mL dry DMSO and compounded with 0.22 g sulfaminic acid. The solution was slowly heated to 80° C. and agitated 3 hours at this temperature. After cooling off, the product was precipitated by pouring the reaction solution into 300 mL ethanol in which 1.0 g NaOH had been dissolved, and was then filtered off, rewashed with ethanol and dried. 1.9 g dark-brown solid were isolated. This solid was dissolved in water at pH 8.5. A part of the salts contained were separated by ultrafiltration using a 100 Dalton membrane. The residue was evaporated to low bulk on a rotary evaporator and freeze-dried. 0.97 g of a brown powder were obtained, designated as B2. The TOC measurement of the dry residue yielded 10.0% organic carbon.

### Reference Tests

The following reference reactions Ref.1, Ref.2, Ref.RG1 and Ref.RG2 were carried out for purposes of comparison:

Sulfatizing of lignin 1: Ref.1

5 g lignin 1 were dissolved in 30 mL dry DMSO, 1.1 g sulfaminic acid was added, and the solution was agitated 3 hours at 80° C. After the mixture had cooled to room temperature, it was poured onto 300 mL ethanol in which 1.0 g NaOH had been dissolved. The precipitated solid was filtered off and rewashed well with ethanol. After drying, the solid was dissolved in water and the solution ultrafiltered with a 1000 Dalton membrane in order to remove the greatest part of the inorganic salts. The residue was freeze-dried and designated as Ref.1. The TOC measurement of the dried residue yielded 53.7% organic carbon.

Sulfatizing of Lignin 2: Ref.2

5 g lignin 2 were dissolved in 30 mL dry DMSO at 35° C. 1.1 g sulfaminic acid were added and the solution agitated 3 hours at 80° C. After it had cooled to room temperature, it was poured onto 300 mL ethanol in which 1.0 g NaOH had been dissolved and the resulting solid was filtered off and rewashed well with ethanol. After drying, the solid was dissolved in water and ultrafiltered with a 100 Dalton membrane in order to remove the majority of the inorganic salts. The residue was freeze-dried and yielded 6.1 g brown powder that was designated as Ref.2. The TOC measurement of the dried residue yielded 53.4% organic carbon.

Sulfatizing of Non-Separated Reaction Mixture RG1: Ref.RG1

The reaction mixture RG1 was evaporated to low bulk on a rotary evaporator and freeze-dried. The 3.68 g solid contained 2.0 g decomposed lignin, which was dissolved in 40 mL dry DMSO. After the addition of 0.44 g sulfaminic acid the reaction mixture was agitated 3 hours at 80° C. After cooling off, it was poured onto 600 mL ethanol in which 2.0 g NaOH had been dissolved and the resulting precipitate was filtered off and rewashed with ethanol. The precipitate that precipitated from the filtrate after 2 days of standing in the refrigerator was also filtered off and combined with the first one. The solid was dissolved in a little water, freeze-dried and yielded 3.9 g powder that was designated as Ref.RG1. The TOC measurement yielded 20.4% organic carbon.

Sulfatizing of Non-Separated Reaction Mixture RG2: Ref.RG2

The reaction mixture RG2 was dried on a rotary evaporator. The residue (2 g, corresponds to 1 g lignin decomposition products) was dissolved in 20 mL dry DMSO and compounded with 0.22 g sulfaminic acid. The solution was slowly heated to 80° C. and agitated 3 hours at this temperature. After cooling off, the product was precipitated by pouring the reaction solution into 300 mL ethanol, in which 1.0 g NaOH had been dissolved, and was filtered. The filtrate was stored 1 week in a refrigerator, and additional solid that precipitated was also filtered off and combined with the first. This solid was dissolved in water and the pH adjusted to 8.5. A part of the salts contained were separated off by ultrafiltration using a 100 Dalton membrane. The residue was evaporated to low bulk on a rotary evaporator and freeze-dried. 0.96 g of a brown powder were obtained, and designated as Ref.RG2. The TOC measurement of the dry residue yielded 32.4% organic carbon.

Mannich Reaction Product of the Separated High-Molecular Lignin Decomposition Product AHLA3:B3

1.3 g of the separated high-molecular lignin decomposition product AHLA3 (corresponding to 1.2 g decomposed lignin) were dissolved in 4 mL water and 0.55 g alanine added and also dissolved. After the addition of 0.51 mL of a 36% formaldehyde solution, the pH was adjusted by the addition of NaOH to approximately 9-10. The mixture was heated under nitrogen for 15 hours at 85° C. and a Mannich base was obtained in this manner. The reaction conversion of alanine was 47%, as was calculated from the decrease of the alanine peak in an HPLC.

Mannich Reaction Product of the Separated High-Molecular Lignin Decomposition Product AHLA4:B4

23.4 g of the separated high-molecular lignin decomposition product AHLA4 with a carbon content of 1.8% were for the most part dissolved in 18.8 mL water. After the addition of 0.40 g DL alanine the pH was adjusted by the addition of 100 mg NaOH to 9-10. 0.35 mL of a 36% formaldehyde solution were added, and after washing with nitrogen the reaction mixture was agitated 16 hours at 85° C. and a Mannich base was obtained in this manner.

### Reference Tests

The following reference reactions Ref.3, Ref.4, Ref.RG3 and Ref.RG4 were carried out for reference purposes:

Mannich Reaction Product of Lignin 2: Ref.3=Ref.4

10 g lignin 2 were dissolved in 30 mL water. 4.8 g DL alanine were added and also dissolved. The pH was adjusted to 9-10 by adding NaOH. 4.2 mL of a 36% formaldehyde solution were added and the solution heated under agitation for 16 hours under nitrogen at 85° C., and a Mannich base was obtained in this manner. The reaction conversion of alanine was 40%, as was calculated from the decrease of the alanine peak in an HPLC.

Mannish Reaction Product of Non-Separated Reaction Mixture RG3: Ref.RG3

The reaction mixture RG3 was adjusted to pH 10 with NaOH, evaporated to low bulk on a rotary evaporator and freeze-dried. 5.9 g of this powder with an organic carbon content of 28.7% (determined by TOC measurement) (corresponds to 3.4 g decomposed lignin) were dissolved in 15 mL water and 1.7 g DL alanine were added and also dissolved. The pH of the solution was adjusted to pH 9-10 by the addition of NaOH. After the addition of 1.5 mL of a 36% formaldehyde solution, the mixture was heated under agitation for 16 hours under nitrogen at 85° C. and a Mannich base was obtained in this manner. The reaction conversion of alanine was 28%, as was calculated from the decrease of the alanine peak in an HPLC.

Mannich Reaction Product of Non-Separated Reaction Mixture RG4: Ref.RG4

The reaction mixture RG4 was brought to pH 10-10.5 with NaOH, evaporated to low bulk on a rotary evaporator and freeze-dried. 12.4 g of a powder were isolated. The TOC measurement yielded a content of organic carbon of 3.6%. 12.3 g (corresponds to approximately 0.9 g decomposed lignin) were compounded with 11.9 mL water and partially dissolved. 0.48 g DL alanine were added and the pH of the solution was adjusted to 9-10 by the addition of 250 mg NaOH. 0.42 mL of a 36% formaldehyde solution were added and the mixture agitated 16 hours under nitrogen at 85° C. and in this manner a Mannich base was obtained.

### Characterization Decomposition by SEC

The mass-averaged molecular weight M_{w} was determined by SEC (Size Exclusion Chromatography) for the characterization of the lignin decomposition. The SEC analysis was carried out on an HPLC system (Alliance 2695, Waters) equipped with a column cascade from the company Polymer Standards Service GmbH (MCX 10 μm 1000 Å, MCX 10 μm 100000 Å+pre-column) and a UV detector (320 nm). 0.01 molar aqueous sodium hydroxide solution was used as the mobile solvent and solvent for lignin and the lignin decomposition products. The calibration was carried out by means of 9 narrow polymer standards from sulfonated polystyrene in the molecular weight range 1,020,000 Da to 3,420 Da. The molecular weight averaged by mass was therefore determined relative to the sulfonated polystyrene.

The measured absorption signal of the UV detector (320 nm) was standardized into the chromatograms at the highest peak (corresponds to the unit (AU) 1). The elution volume (Vₑ) and the corresponding molecular weight M_{w} (g/mol) are plotted as the X axis.

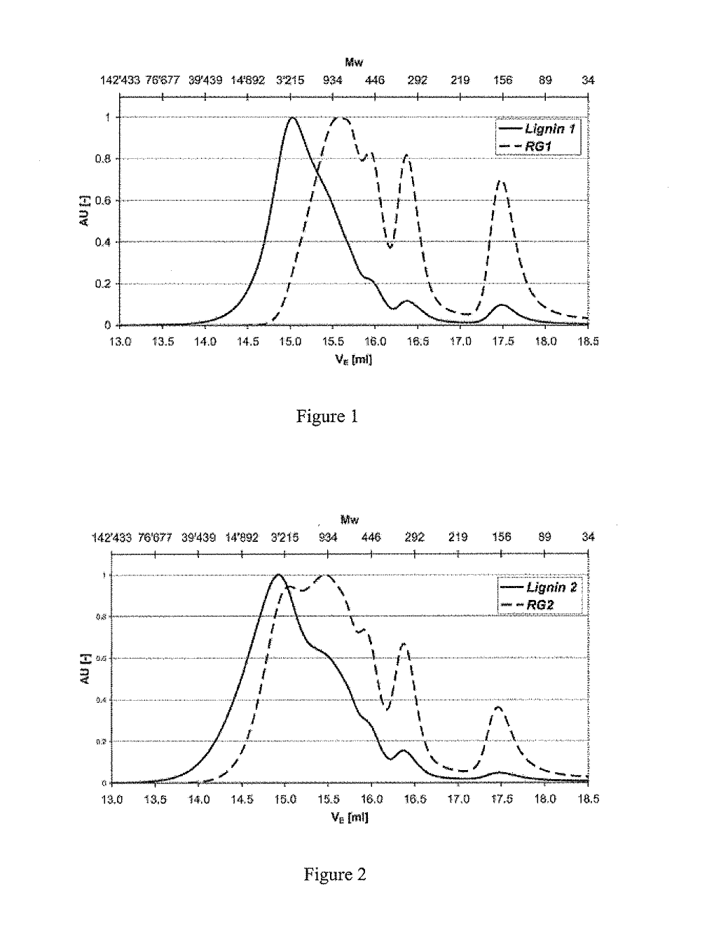

FIG. 1 shows the comparison of the SEC chromatograms of lignin 1 with the reaction mixture RG1.

FIG. 2 shows the comparison of the SEC chromatograms of lignin 2 with the reaction mixture RG2.

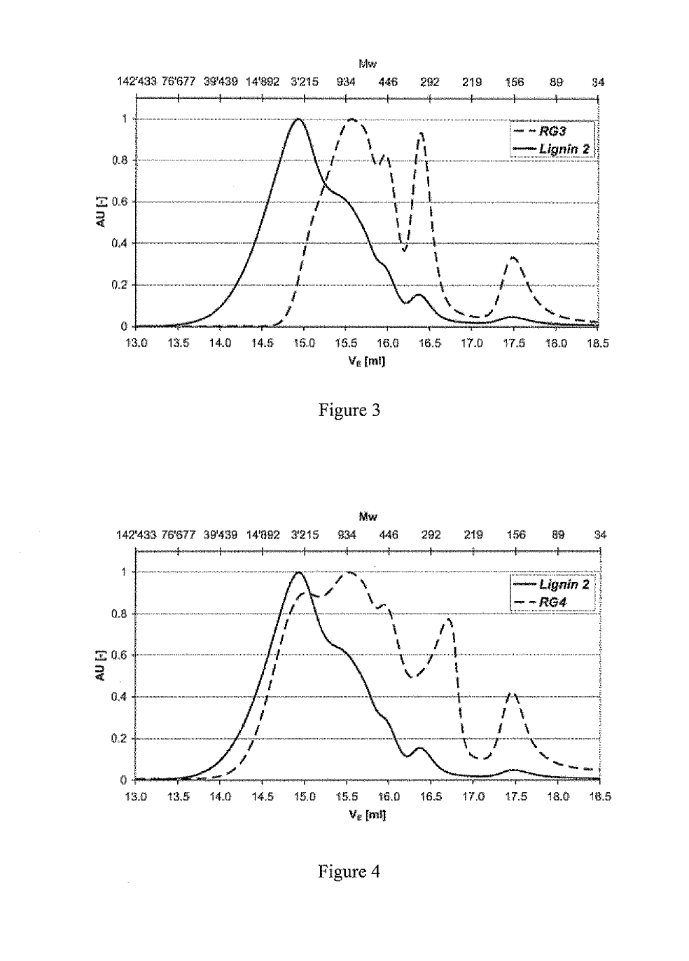

FIG. 3 shows the comparison of the SEC chromatograms of lignin 2 with the reaction mixture RG3.

FIG. 4 shows the comparison of the SEC chromatograms of lignin 2 with the reaction mixture RG4.

It can be seen from the shifting of the molecular weight maximum in the particular reaction mixture that a strong reduction of the molecular weight has taken place during the decomposition.

### Characterization Separation by SEC

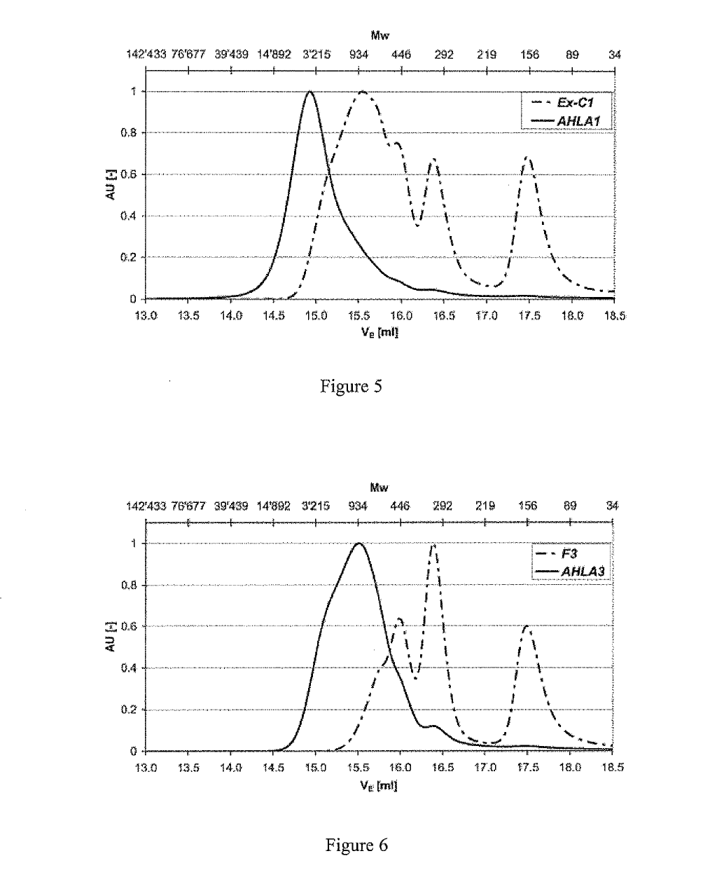

FIG. 5 shows by way of example the comparison of the SEC chromatograms of the chloroform extracts Ex-C1 with the separated high-molecular lignin decomposition product AHLA1 in example 1.

FIG. 6 shows the comparison of the SEC chromatograms of the filtrate F3 and of the separated high-molecular lignin decomposition product AHLA3 of the reaction mixture RG3 in example 3 separated by ultrafiltration.

Both examinations document the fact that the low-molecular constituents were separated from the reaction mixture by extraction or ultrafiltration.

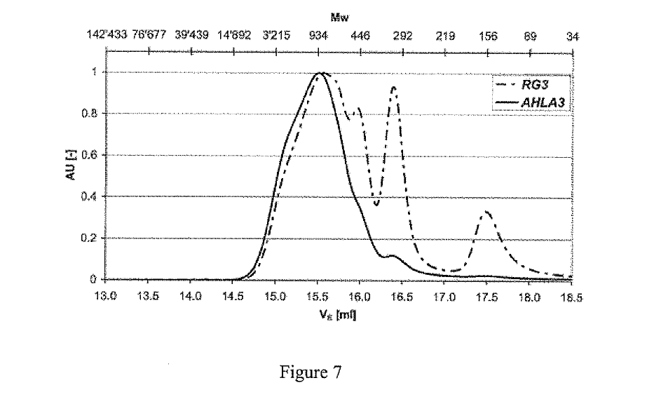

FIG. 7 shows the comparison in example 3 of the SEC chromatograms of the reaction mixture RG3 and of the high-molecular lignin decomposition product AHLA3 separated by ultrafiltration from the reaction mixture RG3.

The standardized SEC chromatograms as shown in FIG. 7 were used for the estimation of the separation of monomers. The monomer peak area of the reaction mixture RG3 (=“A_{M,RG1}”) and of AHLA3 (=“A_{M,AHLA3}”) were determined for the determination of the separation of the monomers (i.e., comprising 1 benzene ring) (elution volume ˜17.5 mL). The separation efficient AE was calculated from this according to the following formula:

AE=(A_{M,RG1}−A_{M,AHLA3})/A_{M,RG1}

The separation efficient AE calculated in this manner for the monomers yielded a value of 98% in example 3.

In the case of the dimers (i.e., comprising 2 benzene rings) (elution volume ˜16.5 mL) and trimers (i.e., comprising 3 benzene rings) (elution volume ˜16 mL) the particular peak areas could not be readily determined without complex deconvulation methods. Therefore, for the sake of simplicity in the calculation of AE, instead of the peak areas the particular peak heights at the peak maximum were used. The corresponding calculation of the separation efficiency for the dimers yielded a value of 87% and for the trimers a value of 54%.

The separated mono-, di- and trimers appear in the SEC chromatogram of the filtrate F3 (permeate). In addition, small amounts of decomposition products larger than trimers can be detected in F3. The largest components that can be found in filtrate F3 have a molecular weight on the order of magnitude of the exclusion boundary (cut-off) of the membrane of 1000 Daltons.

### Application Tests in a Hydraulic Binding Agent

The amounts of lignin or of chemically modified, decomposed lignin indicated in table 1 were weighed in tempering water in a 250 mL, mixing container and dissolved. For this, 200 g of a mixture of 3 Schweizer CEM I 42.5 cements (1:1:1 in parts by weight) were scattered in at a time. The cement paste produced in this manner was thoroughly mixed with a propeller agitator 2 cm in diameter at 2000 rpm for 2 minutes. An open measuring cylinder (50 mm diameter, 51 mm height), standing on a clean glass plate 30 cm in diameter, was filled up plane with the cement paste. The measuring cylinder is raised up so that the cement paste can flow out. The diameter of the cement paste cake formed measures precisely 1 mm and is noted as flow mass (“FM_{2 min}”). After measurement, the cement paste is filled back into the mixing container and the measurement repeated after 30 and 60 minutes from the addition of the tempering water, wherein the cement paste was thoroughly mixed for another 15 seconds and noted as flow mass after 30 minutes (“FM_{30 min}”) and 60 minutes (“FM_{60 min}”).

The following tables show the amount of lignin used each time as wt. % relative to the cement, “m/Z” (calculated by the TOC). In addition, the weight ratio of water to cement “W/Z”, which is important in cement chemistry, is indicated.

Non-decomposed and non-chemically modified lignin 1 was used in reference example R1-0. Non-decomposed and non-chemically modified lignin 2 was used in reference examples R2-0 and R3-0 and R4-0.

It is important to consider in the evaluation of the results in table 1 that the same cement mixture was used only for one measuring series at a time, so that small fluctuations caused by the differing cement have to be taken into consideration in the comparison of results from different measurement series. This explains, for example, the deviations in the values of R3-0 as compared with R4-0.

TABLE 1
Results of lignins or chemically modified lignin decomposition
products in cementitious binding agents.

| | | m/Z | | FM_{2 min} | | FM_{60 min} |
|---|---|---|---|---|---|---|
| Nr. \ | Sample | [%] | W/Z | [mm] | FM_{30 min} [mm] | [mm] |
| R1-0 | Lignin 1 | 0.3 | 0.39 | 135 | 130 | 132 |
| R1-1 | Ref. 1 | 0.3 | 0.39 | 158 | 137 | 140 |
| R1-2 | Ref. RG1 | 0.3 | 0.39 | 147 | 124 | 122 |
| Ex1 | B1 | 0.3 | 0.39 | 170 | 126 | 128 |
| R2-0 | Lignin 2 | 0.3 | 0.39 | 124 | 113 | 115 |
| R2-1 | Ref. 2 | 0.3 | 0.39 | 158 | 135 | 134 |
| R2-2 | Ref. RG2 | 0.3 | 0.39 | 153 | 131 | 137 |
| Ex2 | B2 | 0.1 | 0.39 | 156 | 125 | 129 |
| R3-0 | Lignin 2 | 0.35 | 0.39 | 129 | 117 | 115 |
| R3-1 | Ref. 3 | 0.35 | 0.39 | 137 | 126 | 127 |
| R3-2 | Ref. RG3 | 0.35 | 0.39 | 138 | 121 | 120 |
| Ex3 | B3 | 0.35 | 0.39 | 164 | 152 | 155 |
| R4-0 | Lignin 2 | 0.35 | 0.39 | 139 | 120 | 118 |
| R4-1 | Ref. 4 | 0.35 | 0.39 | 150 | 127 | 123 |
| R4-2 | Ref. RG4 | 0.35 | 0.39 | 179 | n.m.¹ | n.m.¹ |
| Ex4 | B4 | 0.35 | 0.39 | 202 | n.m.¹ | n.m.¹ |

¹n.m. = not measured

It is apparent from the results of table 1 that the examples Ex1. Ext2, Ex3 and Ex4, which contain chemically modified lignin decomposition products B1, B2, B3 and B4 in accordance with the invention, have a considerably better liquefaction (apparent from the flow mass) than the corresponding non-decomposed and non-chemically modified lignins lignin 1 and lignin 2. Furthermore, the results also show that the examples based on chemically modified lignin decomposition products B1, B2, B3 and B4 in accordance with the invention have a relevantly better flow behavior than the reference examples with the corresponding chemically modified decomposition products not separated from the low-molecular decomposition products, and than those reference examples with the chemically modified non-decomposed lignins.

The comparison of example Ex2 with the reference examples R2-1 and R2-2 shows that a comparable flow mass can already be achieved with the addition of B2 in accordance with the invention with only one third of the dosage, as with the reference additives Ref.2 and Ref. RG2.

In spite of the fact that in the Mannich base production non-reacted alanine is still present in the products, this is not important for the flow behavior since a corresponding reference test with an appropriate addition of alanine to the cement paste did not noticeably change the flow behavior.

1. A method for the production of chemically modified lignin decomposition products, comprising the steps:
(a) Decomposition of a starting material selected from the group consisting of lignin, lignin derivatives, lignin fractions and/or lignin-containing substances and mixtures thereof under acidic conditions in the presence of a liquid medium to low-molecular and high-molecular lignin decomposition products, wherein the low-molecular lignin decomposition products have a maximum of three benzene ring units in their chemical structural formula, and the high-molecular lignin decomposition products have more than three benzene ring units in their chemical structural formula,
(b) At least extensive separation of the low-molecular lignin decomposition products in order to obtain a high-molecular fraction, and
(c) Chemical modification of the high-molecular lignin decomposition products contained in the high-molecular fraction to chemically modified lignin decomposition products,
wherein the chemical modification of the high-molecular lignin decomposition products according to step (c) takes place only after steps (a) and (b).

2. The method according to claim 1, wherein the decomposition is carried out in the presence of at least one polyoxometallate.

3. The method according to claim 1, wherein the decomposition is carried out in the presence of at least one acid.

4. The method according to claim 1, wherein the decomposition is carried out at a pH of 0.5 to 6.

5. The method according to claim 1, wherein the decomposition is carried out at a temperature of 20 to 300° C.

6. The method according to claim 1, wherein the decomposition is carried out at a superpressure of 0 to 200 bar.

7. The method according to claim 1, wherein the decomposition is carried out in the presence of N₂, air or O₂.

8. The method according to claim 1, wherein the decomposition is carried out in a continuous process.

9. The method according to claim 1, wherein the decomposition is carried out in the presence of at least one compound that prevents a recombination of decomposition products.

10. The method according to claim 2, wherein the separation of the low-molecular lignin decomposition products in step (b) is such that in the chemically modified lignin decomposition product according to step (c), the amount of the sum of low-molecular lignin decomposition products and chemically modified low-molecular lignin decomposition products is less than 20 wt. %.

11. The method according to claim 1, wherein the chemical modification of the high-molecular lignin decomposition products comprises a reaction selected from the group consisting of addition, condensation and graft polymerization.

12. The method according to claim 1, wherein the chemical modification of the high-molecular lignin decomposition products is carried out by reaction with at least one reactant that is selected from the group consisting of alcohols, carboxylic acids, hydroxy carboxylic acids, amino acids, acid chlorides, acid anhydrides, sulfonic acids, hydroxysulfonic acids, aminosulfonic acids, amidosulfonic acids, esters, lactones, lactams, alkylhalogenides, epoxides, amines, hydroxylamines, sulfuric acid, oleum, chlorosulfonic acid, and olefinically unsaturated compounds.

13. The method according to claim 1, wherein the chemical modification of the high-molecular lignin decomposition products is a radical graft polymerization with at least one olefinically unsaturated compound that is selected in particular from the group consisting of alkenes, dienes, olefinically unsaturated acids, olefinically unsaturated esters, olefinically unsaturated acid anhydrides, olefinically unsaturated amides, olefinically unsaturated ethers and olefinically unsaturated alcohols.

14. The method according to claim 1, wherein the molecular weight M_{W} averaged by mass of the high-molecular lignin decomposition products after step (a) is less than 80% of the molecular weight of the starting material used in step (a).

15. The use of a chemically modified lignin decomposition product produced by a method according to claim 1 as a dispersing agent.

16. A composition containing at least one chemically modified lignin decomposition product produced by a method according to claim 1 and containing at least one hydraulic binding agent.
